(19) United States
(12) Patent Application Publication
(10) Pub. No.: US 2026/0360109 A1
(43) Pub. Date: Nov. 12, 2026

(54) METHOD AND SYSTEM FOR ASSOCIATING TWO OR MORE IMAGES

(71) Applicant: Continental Autonomous Mobility Germany GmbH, Ingolstadt (DE)

(72) Inventors: Gaurav Pawar, Bangalore (IN); Pranavi Nambi, Karimnagar (IN); Saranya Kanagaraj, Coimbatore (IN)

(73) Assignee: Continental Autonomous Mobility Germany GmbH, Ingolstadt (DE)

(21) Appl. No.: 19/114,608

(22) PCT Filed: Sep. 14, 2023
(86) PCT No.: PCT/EP2023/075215

§ 371 Date: Mar. 24, 2025

(30) Foreign Application Priority Data
Sep. 23, 2022 (GB) 2213945.5

(51) Int. Cl. G06V 10/75; G06V 10/147; G06V 10/25; G06V 10/764; G06V 10/82; G06V 20/52; G06V 20/58

(52) U.S. Cl. CPC G06V 10/757; G06V 10/147; G06V 10/25; G06V 10/751; G06V 10/764; G06V 10/82; G06V 20/58; G06V 20/52

(57) ABSTRACT

There is provided a computer-implemented method and system for associating objects over two or more images, the method including: receiving a first image from a first image sensor and a second image from a second image sensor; identifying corresponding points between the first image and second image; approximating a projection matrix between the first image and the second image based on the identified corresponding points, the projection matrix including at least one polynomial equation; and associating at least one identified object in the first image with a corresponding identified object in the second image. The system may be mounted on a vehicle, building, or any infrastructure.

### CROSS-REFERENCE TO RELATED APPLICATIONS

The present application is a National Stage Application under 35 U.S.C. § 371 of International Patent Application No. PCT/EP2023/075215 filed on Sep. 14, 2023, and claims priority from Great Britain Patent Application No. 2213945.5 filed on Sep. 23, 2022, in the United Kingdom Intellectual Property Office, the disclosures of which are herein incorporated by reference in their entireties.

### TECHNICAL FIELD

The invention relates generally to computer vision, and more specifically to a method and system for associating objects between two or more images captured by separate image sensors.

### BACKGROUND

In many computer vision applications, it is necessary to track multiple objects across multiple cameras, which is a process known as multiple target multiple camera (MTMC) tracking. MTMC tracking is employed in several applications, including driving where multiple traffic participants, such as vehicles and pedestrians, as well as infrastructure, are tracked across multiple cameras. In many MTMC tracking methods, wide-angle or ultra-wide field of view cameras, also known as fisheye cameras, are preferred as they have a wider field of view compared to rectilinear cameras and thus the images captured by fisheye cameras, also known as fisheye images, contain more information than rectilinear images. An element for MTMC tracking is the representation of a scene captured by multiple cameras in one common coordinate system. Such representation uses pixel-to-pixel mapping between two images, which is particularly difficult with fisheye images due to the distortion present in such fisheye images.

Current approaches to solving the problems associated with pixel-to-pixel mapping of fisheye images use either image rectification or image registration, both of which have several shortcomings. Image rectification involves the alignment of the image planes of two fisheye cameras using camera calibration parameters, which is undesirable as camera calibration parameters are difficult to compute, require human intervention for reliable detection of calibration points and must be recomputed for every new setup as well as periodically due to potential shifts in the position of the camera or lens aberration. In addition, a significant overlapping region exists for efficient image rectification. On the other hand, image registration involves identification of corresponding points, also known as keypoints, between two image planes after distortion correction, and pixel-to-pixel mapping between the images using a transformation calculated between the identified corresponding points. Affine transformation is usually used to approximate the geometric transformation between two image planes, but because affine transformation approximates rigid-body transformation, affine transformation cannot be applied to the non-rigid transformation between the image planes of a rectilinear camera and a fisheye camera, or between the image planes of two fisheye cameras. In addition, a significant overlapping region exists for efficient image registration, and keypoint matching between two images is challenging as the camera view is different for the same object.

### SUMMARY

Embodiments of the present disclosure improve mapping of images by associating between two or more images using a projection matrix for transformation between two image planes or images. In some embodiments, the projection matrix may use polynomial equations and coefficients to approximate the non-rigid transformation between. The projection matrix may be used for pixel-to-pixel mapping between images to facilitate object association between images to enable tracking multiple objects across two or more cameras which may be used for subsequent applications, such as driving, computer vision applications, as well as security or surveillance applications.

To solve the above technical problems, the present disclosure provides a vehicle including for associating objects over two or more images, wherein the vehicle system includes at least a first image sensor and a second image sensor, one or more processors and a memory that stores executable instructions for execution by the one or more processors, the executable instructions including instructions for performing a computer-implemented method including:
receiving a first image from the first image sensor and a second image from the second image sensor;
identifying corresponding points between the first image and the second image;
approximating a projection matrix between the first image and the second image based on the identified corresponding points; and
associating at least one identified object in the first image with a corresponding identified object in the second image based at least on the approximated projection matrix.

The vehicle system of the present disclosure carries out a computer-implemented method that is fully automated and does not require human intervention. The association of objects over two or more images by identifying corresponding points between images and approximating a projection matrix can be triggered automatically, thus avoiding the requirement for manual trigger or recomputation. The computer-implemented method has several advantages over the previous solutions. Unlike image rectification, the computer-implemented method of the present disclosure does not rely on calibration parameters, which is labour-intensive and prone to errors when carried out automatically. The computer-implemented method of the present disclosure is more computationally efficient as it does not require distortion correction. In addition, the computer-implemented method of the present disclosure is also advantageous as it does not require a significant overlap between the field of view of the image sensors and/or images captured by the image sensors.

A vehicle of the present disclosure is a vehicle as described above, wherein the one or more processors and the memory that stores executable instructions for execution by the one or more processors, the executable instructions including instructions for performing a computer-implemented method including:
receiving a first image from the first image sensor and a second image from the second image sensor;
identifying corresponding points between the first image and the second image;
approximating a projection matrix between the first image and the second image based on the identified corresponding points;
associating at least one identified object in the first image with a corresponding identified object in the second image based at least on the approximated projection matrix; and
plotting the positions of identified objects on one common image plane, wherein the one common image plane covers the 360° surround view of objects around the vehicle.

The above-described aspect of the present disclosure has the advantage that the one common image plane including the positions of identified objects may be more representative of the position of objects than an image taken by a single fisheye camera with a large field of view which distorts the objects and their positions.

The above-described advantageous aspects of a vehicle of the present disclosure also hold for all aspects of a below-described computer-implemented method of the present disclosure. All below-described advantageous aspects of a computer-implemented method of the present disclosure also hold for all aspects of an above-described vehicle of the present disclosure.

The present disclosure also relates to a computer-implemented method for associating objects over two or more images, the method including:
receiving a first image from a first image sensor and a second image from a second image sensor;
identifying corresponding points between the first image and the second image;
approximating a projection matrix between the first image and the second image based on the identified corresponding points; and
associating at least one identified object in the first image with a corresponding identified object in the second image based at least on the approximated projection matrix.

The computer-implemented method of the present disclosure is fully automated and does not require human intervention. The association of objects over two or more images by approximating a projection matrix can be triggered automatically, thus avoiding the requirement for manual trigger or recomputation. Furthermore, the computer-implemented method of the present disclosure has several advantages over the previous solutions. Unlike image rectification, the computer-implemented method of the present disclosure does not rely on calibration parameters, which is labour-intensive and prone to errors when carried out automatically. The computer-implemented method of the present disclosure is more computationally efficient as it does not require distortion correction. In addition, the computer-implemented method of the present disclosure is also advantageous as it does not require a significant overlap between the field of view of the image sensors and/or images captured by the image sensors.

A method of the present disclosure is a computer-implemented method as described above, wherein the first image sensor and/or the second image sensor is a fisheye camera, and/or wherein the first image sensor and second image sensor are positioned such that there is an overlap between the at least one first image of the scene captured by the first image sensor and the at least one second image of the scene captured by the second image sensor.

The above-described aspect of the present disclosure has the advantage that a fisheye camera has a wider field of view. The wider the field of view, the larger the overlapping region between the images generated by the cameras. This would enable the usage of less cameras to cover a larger region. For example, less cameras may be used to obtain a 360°-view of the surrounding of an ego vehicle, which may be useful for driving applications.

A method of the present disclosure is a computer-implemented method as described above, wherein:
the corresponding points are distinct points, points that correspond to a vertex or an intersection; and/or
the corresponding points are keypoints.

The above-described aspect of the present disclosure has the advantage that distinct points such as points corresponding to a vertex or an intersection, as well as keypoints, are distinctive points in an image can be identified in an image regardless of orientation or distortion. The usage of points that correspond to a vertex or an intersection is advantageous as they are well-defined and easily detected, thus ensuring that the same points are accurately detected and selected in both the first and second image.

A method the present disclosure is a computer-implemented method as described above, wherein the keypoints are selected using a neural network, and a neural network including a convolutional neural network backbone and a keypoint extractor, wherein the convolutional neural network backbone includes a restricted deformable convolution module.

The above-described aspect of the present disclosure has the advantage that using a neural network to select keypoints allows the learning and modelling of non-linear and complex relationships and subsequent application to new datasets or input. In addition, neural networks have the ability to learn by themselves and product an output that is not limited to the input provided. A convolutional neural network (CNN) backbone is a CNN has high accuracy in image recognition and can automatically filter images and detect features without any human supervision, and a CNN with a restricted deformable convolution accounts for distortions in fisheye images.

A method of the present disclosure is a computer-implemented method as described above, wherein the step of approximating a projection matrix includes the approximating of at least one projection matrix including at least one polynomial equation, wherein the at least one polynomial equation has a degree of n and the number of corresponding points identified is between n+1 and n+7, wherein n is an integer equals to or more than 2 and/or wherein the at least one polynomial equation has a degree of 2 and the number of corresponding points identified is between 3 and 9.

The above-described aspect of the present disclosure is advantageous as, unlike affine transformation in image registration that is limited to rigid-body transformation, the usage of polynomial equations allows the approximation of non-rigid transformations and/or projections, as well as accounts for the non-linear geometry or distortion that is present in fisheye images. Using polynomial equations having a degree of n and having between n+1 and n+7 corresponding points is advantageous as the polynomial equation approximated may be accurate and sufficient for its purpose without overfitting. Using polynomial equations having a degree of 2 and having between 3 and 9 corresponding points is also advantageous as the polynomial equation having a degree of 2 may be sufficient for an accurate fit for its purpose without overfitting in many cases.

A method of the present disclosure is a computer-implemented method as described above, wherein the projection matrix includes two polynomial equations: a first polynomial equation for coordinates on an x-axis, and a second polynomial equation for coordinates on a y-axis.

The above-described aspect of the present disclosure has the advantage that the accuracy of the method is increased as a different polynomial equation is calculated for the x-axis and γ-axis. The different polynomial equations for the x-axis and γ-axis account for the varying distortion along the x-axis and γ-axis in images, particularly in fisheye images.

A method of the present disclosure is a computer-implemented method as described above, wherein associating at least one identified object in the first image with a corresponding identified object in the second image includes:
identifying at least one object in the first image and at least one object in the second image;
generating at least one first bounding box in the first image and at least one second bounding box in the second image, each of the at least one first bounding box and at least one second bounding box representing a spatial location of an identified object; and
associating each first bounding box with a corresponding second bounding box at least based on a relationship between a projection of the first bounding box and the corresponding second bounding box, wherein the projection is based on the approximated projection matrix.

The above-described aspect of the present disclosure has the advantage that the approximated projection matrix allows accurate projection of the positions of a plurality of objects or bounding boxes from the first image to the second image for comparison and association as a group or on a large scale.

A method of the present disclosure is a computer-implemented method as described above, wherein associating each first bounding box with a corresponding second bounding box includes:
projecting the at least one first bounding box on the second image based on the approximated projection matrix to generate at least one projected first bounding box on the second image, wherein each projected first bounding box corresponds to one of the at least one first bounding box;
determining a relationship between each projected first bounding box with each second bounding box; and
associating each first bounding box with a corresponding second bounding box based on the determined relationship between a corresponding projected first bounding box and the corresponding second bounding box.

The above-described aspect of the present disclosure has the advantage that the association or matching between a plurality of objects or bounding boxes in the first image and a plurality of objects or bounding boxes in the second image is optimized as a group or on a large scale based on the positions of the plurality of objects or bounding boxes.

A method of the present disclosure is a computer-implemented method as described above, wherein the relationship between each projected first bounding box with each second bounding box includes:
an extent of overlap between each projected first bounding box and each second bounding box; and/or
a distance between each projected first bounding box and each second bounding box, wherein the distance is between a center of each projected first bounding box and a center of each second bounding box.

The above-described aspect of the present disclosure has the advantage that the positions of a plurality objects or bounding boxes can be projected and matched at the same time across two or more image sensors.

A method of the present disclosure is a computer-implemented method as described above, wherein associating each first bounding box with a corresponding second bounding box further includes:
identifying at least one feature of each identified object in the first image and second image, wherein the at least one feature is an appearance feature vector; and
comparing the at least one feature of each identified object in the first image with the at least one feature of each identified object in the second image.

The above-described aspect of the present disclosure has the advantage that in addition to the position of the objects or bounding boxes, the visual features or appearances of the objects are also compared to ensure increased accuracy of the computer-implemented method as the visual similarity of the objects are also accounted for during the association. This is particularly advantageous in situations where there is a low overlapping region between the first image and the second image.

A method of the present disclosure is a computer-implemented method as described above, wherein the method further includes plotting the positions of identified objects on a common image plane, wherein the common image plane covers the 360° surround view of objects around the first, second and further image sensors.

The above-described aspect of the present disclosure has the advantage that the plotting of the positions of objects on a common image plane provides an accurate representation of spatial positions of objects within a scene. The one common image plane including the positions of identified objects may be more representative of the position of objects than an image taken by a single fisheye camera with a large field of view which distorts the objects and their positions.

A particular method of the present disclosure is a computer-implemented method as described above, wherein:
the first image sensor and second image sensor are fisheye cameras and are positioned such that there is an overlap between the at least one first image of the scene captured by the first image sensor and the at least one second image of the scene captured by the second image sensor;
the corresponding points are selected using a neural network including a convolutional neural network backbone and a keypoint extractor, wherein the neural network is trained on a scene classification dataset including images sorted into scene classes, wherein each scene class includes a sequence of images captured from a single camera that captures overlapping regions of a scene and a sequence of images captured at a same time period by other cameras that have an overlapping field of view with the single camera, and wherein the convolutional neural network backbone includes a restricted deformable convolution module;
the approximated projection matrix includes a first polynomial equation for coordinates on an x-axis, and a second polynomial equation for coordinates on a y-axis, wherein the first polynomial equation and second polynomial equation each have a degree of 2 and the number of corresponding points identified is 3;
associating at least one identified object in the first image with a corresponding identified object in the second image includes:
   identifying at least one object in the first image and at least one object in the second image;
   generating at least one first bounding box in the first image and at least one second bounding box in the second image, each of the at least one first bounding box and at least one second bounding box representing a spatial location of an identified object;
   projecting the at least one first bounding box on the second image based on the approximated projection matrix to generate at least one projected first bounding box on the second image, wherein each projected first bounding box corresponds to one of the at least one first bounding box;
   determining an extent of overlap between each projected first bounding box and each second bounding box; and
   associating each first bounding box with a corresponding second bounding box based on the determined extent of overlap between a corresponding projected first bounding box and the corresponding second bounding box.

The above-described advantageous aspects of a vehicle or computer-implemented method of the present disclosure also hold for all aspects of a below-described training dataset of the disclosure. All below-described advantageous aspects of a training dataset of the disclosure also hold for all aspects of an above-described vehicle or computer-implemented method of the disclosure.

The disclosure also relates to a training dataset for a neural network, in particular the neural network according to the disclosure, wherein the training dataset includes images sorted into scene classes, wherein each scene class includes:
a sequence of images captured from a first image sensor that captures overlapping regions of a scene;
optionally, a sequence of images captured at a same time period by other image sensors that have an overlapping field of view with the first image sensor; and
optionally, images altered from the sequence of images captured from the first image sensor and/or sequence of images captured at a same time period by other image sensors that have an overlapping field of view with the first image sensor.

The training dataset of the present disclosure is advantageous as it includes a large number of images for each scene class for the training of a neural network for keypoint identification. The training dataset includes a large variety of images for each scene class from limited images and limited image sensors.

The above-described advantageous aspects of a vehicle, computer-implemented method, or training dataset of the disclosure also hold for all aspects of a below-described system of the disclosure. All below-described advantageous aspects of a system of the disclosure also hold for all aspects of an above-described vehicle, computer-implemented method, or training dataset of the disclosure.

The disclosure also relates to a system adapted to be used in a vehicle including at least a first image sensor and a second image sensor, one or more processors and a memory that stores executable instructions for execution by the one or more processors, the executable instructions including instructions for performing a computer-implemented method according to the disclosure.

The above-described advantageous aspects of a vehicle, computer-implemented method, training dataset, or system of the disclosure also hold for all aspects of a below-described computer program, machine-readable medium, or a data signal of the disclosure. All below-described advantageous aspects of a computer program, machine-readable medium, or a data signal of the disclosure also hold for all aspects of an above-described vehicle, computer-implemented method, training dataset, or system of the disclosure.

The disclosure also relates to a computer program, a machine-readable medium, or a data carrier signal that includes instructions, that upon execution on one or more processors, cause the one or more processors to perform a computer-implemented method according to the disclosure. The machine-readable medium may include any medium and/or mechanism for storing or transmitting information in a form readable by a machine (e.g., a computing device). The machine-readable medium may be any medium, such as for example, read-only memory (ROM); random access memory (RAM); a universal serial bus (USB) stick; a compact disc (CD); a digital video disc (DVD); a data storage device; a hard disk; electrical, acoustical, optical, or other forms of propagated signals (e.g., digital signals, data carrier signal, carrier waves), or any other medium on which a program element as described above can be transmitted and/or stored.

As used in this summary, in the description below, in the claims below, and in the accompanying drawings, the term “scene” refers to a distinct physical environment that may be captured by one or more image sensors. A scene may include one or more objects that may be visually captured by one or more image sensors, whether such object is stationary or mobile.

As used in this summary, in the description below, in the claims below, and in the accompanying drawings, the term “fisheye camera” refers to an image sensor, camera and/or video camera equipped with a fisheye or wide-angle lens having a field of view of not less than 60 degrees, and the term “fisheye image” refers to an image captured or generated by a fisheye camera. A fisheye image may also be characterized as a spherical or hemispherical image.

As used in this summary, in the description below, in the claims below, and in the accompanying drawings, the term “bounding box” refers to a bounding region of an object, and may include a bounding box, a bounding circle, a bounding ellipse, or any other suitably shaped region representing an object. A bounding box associated with an object can have a rectangular shape, a square shape, a polygon shape, a blob shape, or any other suitable shape.

As used in this summary, in the description below, in the claims below, and in the accompanying drawings, the term “vehicle” refers to any mobile agent capable of movement, including cars, trucks, buses, agricultural machines, forklift, robots, whether or not such mobile agent is capable of carrying or transporting goods, animals, or humans.

As used in this summary, in the description below, in the claims below, and in the accompanying drawings, the term “keypoint” refers to a region of an image which is particularly distinct and identifies a unique feature. Keypoints are used to identify key regions of an object that are used as the base to later match and identify it in another image.

As used in this summary, in the description below, in the claims below, and in the accompanying drawings, the terms “keypoint descriptors” or “local descriptors” refer to image patches around keypoints as high-dimensional points in feature space. Keypoint descriptors or local descriptors include edge and/or colour information that is invariant to small affine transformations and keep spatial relations. Keypoint descriptors or local descriptors may also include shape, texture and/or semantic information.

As used in this summary, in the description below, in the claims below, and in the accompanying drawings, the term “feature” refers to the variables, attributes, properties, or characteristics in a dataset, and the terms “feature map”, “activation map” or “convolved feature” may refer to a set of features output by a certain layer of a neural network after a filter (also known as a kernel or feature detector) including vectors of weights and biases that are applied to an input dataset.

### BRIEF DESCRIPTION OF THE DRAWINGS

These and other features, aspects, and advantages will become better understood with regard to the following description, appended claims, and accompanying drawings where:

FIG. 1 is a schematic illustration of a system for associating objects over two or more images, in accordance with embodiments of the present disclosure;

FIG. 2 is a schematic illustration of a method for associating objects over two images, in accordance with embodiments of the present disclosure;

FIG. 3 illustrates example corresponding first image and second image, in accordance with embodiments of the present disclosure;

FIG. 4 illustrates example corresponding points identified and matched between example first image and second image, in accordance with embodiments of the present disclosure;

FIG. 5 is a schematic illustration of an exemplary method of associating each of one of more identified objects in a first image with a corresponding object in the second image, in accordance with embodiments of the present disclosure;

FIG. 6 is a schematic illustration of a method of associating each first bounding box with a corresponding second bounding box, in accordance with embodiments of the present disclosure;

FIG. 7 illustrates example first image and second image after projection, in accordance with embodiments of the present disclosure;

FIG. 8 is a schematic illustration of a top view of a vehicle with image sensors mounted, in accordance with embodiments of the present disclosure; and

FIG. 9 is a schematic illustration of an architecture of a trained neural network for the identification of corresponding points, in accordance with embodiments of the present disclosure.

In the drawings, like parts are denoted by like reference numerals.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the summary above, in this description, in the claims below, and in the accompanying drawings, reference is made to particular features (including method steps) of the disclosure. It is to be understood that the present disclosure in this specification includes all possible combinations of such particular features. For example, where a particular feature is disclosed in the context of a particular aspect or embodiment of the disclosure, or a particular claim, that feature can also be used, to the extent possible, in com-bination with and/or in the context of other particular aspects and embodiments of the disclosure, and in the disclosures generally.

In the present document, the word “exemplary” is used herein to mean “serving as an example, instance, or illustration.” Any embodiment or implementation of the present subject matter described herein as “exemplary” is not necessarily be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the scope of the disclosure.

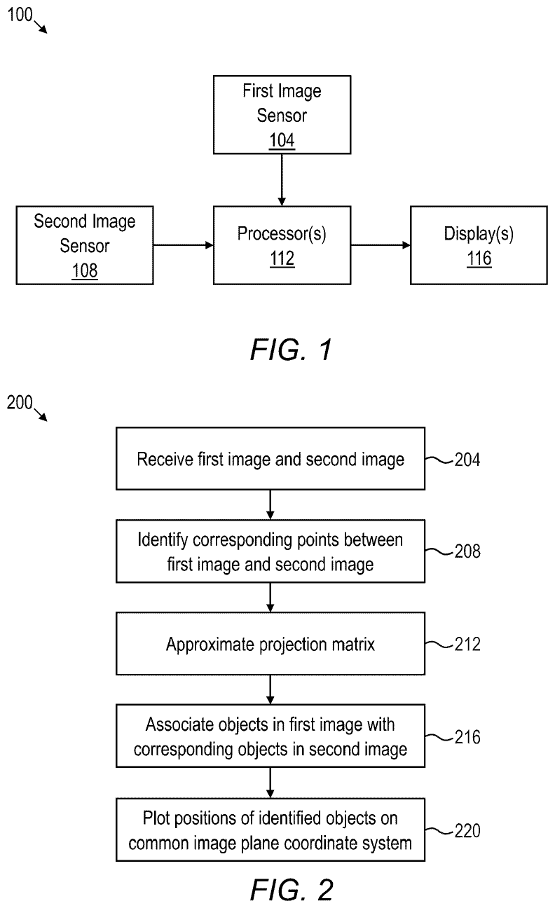

FIG. 1 is a schematic illustration of a system for associating objects over two or more images, in accordance with embodiments of the present disclosure. System 100 for associating objects over two or more images may include a first image sensor 104, a second image sensor 108, one or more processors 112, and one or more displays 116. Although only a first image sensor 104 and a second image sensor 108 are illustrated, system 100 may include more than two image sensors in some embodiments.

According to some embodiments, the first image sensor 104 and the second image sensor 108 may be visible light sensors which capture information relating to the colour of objects in a scene. In some embodiments, the first image sensor 104 and/or the second image sensor 108 may be a camera or a video camera. In some embodiments, the first image sensor 104 may be operable to provide at least one first image, and the second image sensor 108 may be operable to provide at least one second image. In some embodiments, the first image sensor 104 and/or second image sensor 108 may be an image sensor, camera, and/or video camera equipped with a standard lens. The first image sensor 104 and/or the second image sensor 108 may be a fisheye camera which is an image sensor, camera and/or video camera equipped with a fisheye or wide-angle lens having a field of view of not less than 60 degrees.

According to some embodiments, the first image sensor 104 may be positioned to capture a scene from a first direction and the second image sensor 108 may be positioned to capture the same scene from a second direction, the first image sensor 104 and second image sensor 108 positioned such that there is an overlap between the at least one first image of the scene captured by the first image sensor 104 and the at least one second image of the scene captured by the second image sensor 108. In general, the larger the overlapping region, the more accurate the results, and the first image sensor 104 and second image sensor 108 may be adjusted and customised based on a user's desired accuracy and desired scene coverage. For example, where the overlap is above 50% of the region of interest, distortion of the image plane may be mathematically modelled in the method of the present disclosure with higher accuracy with lower scene coverage. For examples, where the overlap is less than 50% of the region of interest, distortion may still be modelled in the method of the present disclosure with lower accuracy with higher scene coverage. In some embodiments, the scene may be a scene surrounding a vehicle, a scene along a corridor, a scene surrounding a building, a scene within a room, or any other scene where identification and/or tracking of objects, persons, or participants may be useful. The first image sensor 104 and second image sensor 108 may be mounted anywhere, at any position, and at any height depending on the scene they are used to capture. In some embodiments, the first image sensor 104 and second image sensor 108 may be mounted on a vehicle and positioned to capture a scene around the vehicle. In some embodiments, the first image sensor 104 and second image sensor 108 may be mounted on an exterior of a building and positioned to capture a scene around the building. In some embodiments, the first image sensor 104 and second image sensor 108 may be mounted along a corridor and positioned to capture a scene of the corridor.

According to some embodiments, the one or more processors 112 may be coupled to the first image sensor 104 and second image sensor 108 to receive the at least one image captured by the first image sensor 104 and the at least one second image captured by the second image sensor 108. The one or more processors 112 may be operable to identify and associate one or more objects that are found in both the at least one first image and the at least one second image. The association method will be described in detail later.

According to some embodiments, the one or more processors 112 may be coupled to one or more displays 116. In some embodiments, the one or more displays 116 may display the at least one first image captured by the first image sensor 104 and/or the at least one second image captured by the second image sensor 108 that were received by the one or more processors 112. In some embodiments, the one or more displays 116 may display markings, shadings, or any other indicators generated by the one or more processors 112. Examples of such markings or indications may include tracker identity labels, bounding boxes, projected bounding boxes, keypoints, and points.

FIG. 2 is a schematic illustration of a method for associating objects over two images, in accordance with embodiments of the present disclosure. Although the present disclosure discusses the method in relation to two images, the method may be scaled to associate objects over more than two images, as long as there is a region of overlap between the images. Method 200 for associating objects over two images may be implemented by any architecture and/or computing system. For example, various architectures employing, for example, multiple integrated circuit (IC) chips and/or packages, and/or various computing devices and/or consumer electronic (CE) devices such as multi-function devices, tablets, smart phones, etc., may implement the techniques and/or arrangements described herein.

According to some embodiments, method 200 for associating objects over two images may commence at operation 204, wherein a first image is received from first image sensor 104 and a second image is received from second image sensor 108. The first image and second image are images that are taken across different views of the same scene. There is an overlap between the first image and the second image, wherein an overlapping or common region is captured in both the first image and the second image. The overlapping region may be any proportion of the first image and/or second image. The overlapping region is above 50% of the first image and/or second image, although the method has acceptable accuracy even with overlapping regions of less than 50%. In some embodiments, the first image and second image may be taken sequentially by the first image sensor 104 and the second image sensor 108. The first image and second image are taken simultaneously by the first image sensor 104 and second image sensor 108. The first image and second image have the same time stamp.

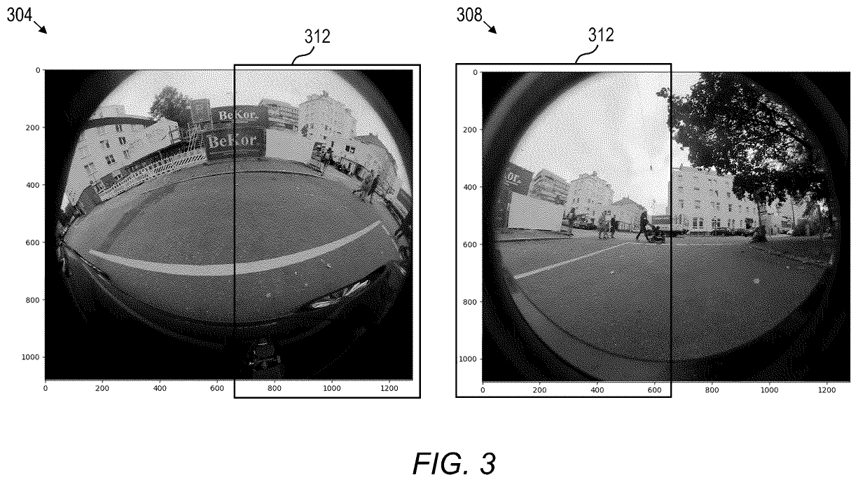

FIG. 3 illustrates an example of a first image 304 and an example of a second image 308, in accordance with embodiments of the present disclosure. As shown, first image 304 and second image 308 contain image content on a fisheye image plane. In other embodiments, first image 304 and second image 308 may contain image content on a rectilinear image plane. As shown in FIG. 3, first image 304 and second image 308 cover different views of a same scene, with an overlapping region 312 captured in both first image 304 and second image 308.

Returning to FIG. 2, method 200 may include operation 208, wherein corresponding points between the first image and second image are identified. Corresponding points are image points that are present or found in both the first image captured by the first image sensor 104 and the second image captured by the second image sensor 108. In some embodiments, each identified corresponding point may include image point data, which may include any suitable data or data structure indicating the identified image point such as a location and/or point vector for each identified point. The point vector may include any data structure such as a vector of values indicating characteristics of a particular point (e.g., measures of various parameters characteristic of the point). For example, the point location may be a pixel location.

According to some embodiments, operation 208 may include the identification of image points in the first image and second image, and the matching of image points in the first image and second image to identify corresponding image points. In some embodiments, the image points identified may be generally geometrically invariant, i.e., invariant to image translation, rotation and scale, as well as photometrically invariant, i.e., invariant to changes in brightness, contrast and colour, which may increase the ease of identifying and matching the corresponding point in the first image and second image. In some embodiments, the image points identified may be points that correspond to a vertex or an intersection, which may increase the ease of identifying and matching the corresponding point in the first image and second image. In some embodiments, the image points identified may be distinct points, also known as keypoints, or pixels of highly distinct or differentiable visual features.

According to some embodiments, the identification of image points may be carried out manually or using any suitable technique(s) to detect or identify suitable image-based features, such image-based features detected based on features extracted using image information such as pixel values. Examples of methods that may be used to identify image points include, but are not limited to, the method for extracting distinctive invariant features disclosed in “Distinctive Image Features from Scale-Invariant Keypoints” by David G. Lowe, SURF (Speeded Up Robust Features) disclosed in “SURF: Speeded Up Robust Features” by Bay et. al., BRISK (Binary Robust Invariant Scalable Keypoints) disclosed in “BRISK: Binary Robust Invariant Scalable Keypoints” by Leutenegger et. al., and ORB (Oriented FAST and Rotated BRIEF) disclosed in “ORB: an efficient alternative to SIFT or SURF” by Rublee et. al.

According to some embodiments, the image points defined in the first image may be compared against the image points identified in the second image to identify corresponding or matching points found in both the first image and second image. The comparison and matching of points may be carried out using any known image analysis methods for cross-matching purposes, such as similarity-based or template matching. The comparison and cross-matching may be repeated between each possible pair of points until all identified points have been processed. An example of an algorithm that may be employed is the Random Sample Consensus (RANSAC) algorithm disclosed by Fischler, A. M. & Bolles, R. C in “Random Sample Consensus: A Paradigm for Model Fitting with Applications to Image Analysis and Automated Cartography”.

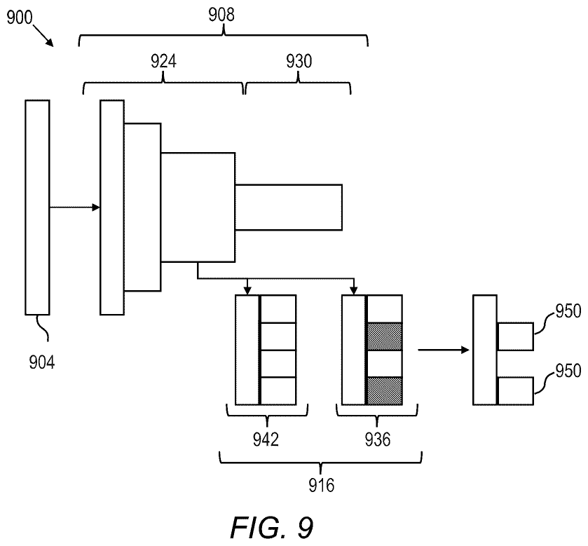

According to some embodiments, operation 208 of identifying corresponding points between the first image and the second image may be carried out using a neural network, the neural network trained to use features within an image to identify and match keypoints. Examples of the architecture and training of the neural network for identification of corresponding points is discussed in further detail in relation to FIG. 9.

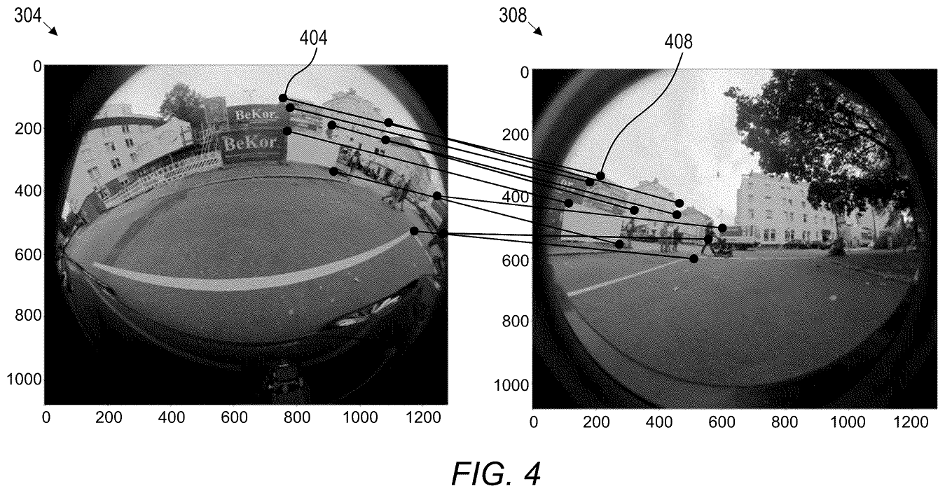

FIG. 4 illustrates example corresponding points identified and matched between example first image 304 and second image 308, in accordance with embodiments of the present disclosure. As shown, multiple image points 404 are identified in first image 304 and multiple image points 408 are identified in second image 308. In FIG. 4, each image point 404 or 408 is indicated by a dot representing a pixel location in the first image 304 or second image 308. Each image point 404 identified in first image 304 may be matched with a corresponding image point 408 in second image 308. As shown, the image points identified in first image 304 and second image 308 are distinct points such as the corners of signs, corners of buildings, a corner of a road surface marker, or a corner of a truck.

Returning to FIG. 2, method 200 may include operation 212 wherein a projection matrix is approximated between the first image and second image based on the corresponding points identified in operation 208. The projection matrix represents a geometric and/or transformational relationship between a point of the first image with a corresponding point of the second image.

According to some embodiments, approximating the projection matrix includes approximating at least one polynomial equation. A polynomial equation is an algebraic equation that with the general formula,

P(x)=aₙxⁿ+aₙ₋₁xⁿ⁻¹+. . . +a₂x²+a₁x+a₀ (1)

where a₀, . . . , aₙ are coefficients of the polynomial equation, x is the indeterminate that may be substituted for any value, and the exponent n on the indeterminate x may be any integer representing the degree of the indeterminate x.

According to some embodiments, the first image and/or the second image may be a fisheye image. In such embodiments, the geometric relationship between the first image and second image is non-linear and the polynomial equation may have a degree of n and the number of corresponding points identified is between n+1 and n+7, wherein n is an integer equals to or more than 2. In some embodiments, the polynomial equation has a degree of 2 and the number of corresponding points identified may be between 3 and 9 to reduce computing power required while maintaining sufficient accuracy without overfitting. In some embodiments, the degree of the polynomial may be independent of the number of corresponding points.

According to some embodiments, the number of corresponding points used to approximate the projection matrix in operation 212 may be less than the number of corresponding points identified in operation 208. In some embodiments, the corresponding points used to approximate the projection matrix in operation 212 may be selected in a distributed manner to cover a maximum area in the overlap between the first image and the second image.

According to some embodiments, the projection matrix may include two polynomial equations: a first polynomial equation for coordinates on an x-axis, and a second polynomial equation for coordinates on a y-axis. The position or location of each pixel or point on an image may be expressed as 2-dimensional (2D) coordinates that may be expressed as (x, y), wherein x represents an x-coordinate, and y represents a y-coordinate. In some embodiments, the x-coordinate may be transformed based on the first polynomial equation and the y coordinate may be transformed based on the second polynomial equation.

For example, a projection matrix including two polynomial equations may be represented as:

$$( \begin{matrix}P ( x ) = {a}_{n} {x}^{n} + {a}_{n - 1} {x}^{n - 1} + … + {a}_{2} {x}^{n} + {a}_{1} x + {a}_{0} \\ P ( y ) = {b}_{n} {y}^{n} + {b}_{n - 1} {y}^{n - 1} + … + {b}_{2} {y}^{n} + {b}_{1} y + {b}_{0}\end{matrix} ) \qquad ( 2 )$$

where P(x) represents the first polynomial equation for coordinates on an x-axis, P(y) represents the second polynomial equation for coordinates on a y-axis, a₀, . . . , aₙ are coefficients of the first polynomial equation, b₀, . . . , bₙ are coefficients of the second polynomial equation, x is the indeterminate for the first polynomial equation that may be substituted for the x-coordinates, y is the indeterminate for the second polynomial equation that may be substituted for the y-coordinates, and the exponent n on the indeterminates x or y may be any integer representing the degree of the indeterminate x or y.

According to some embodiments, the coefficients a₀, . . . , aₙ of the at least one polynomial equation may be determined through any known curve fitting method that identifies a best fit polynomial equation to a series of data points. An example of a known method is the 2D polynomial transformation function of the skimage library in python.

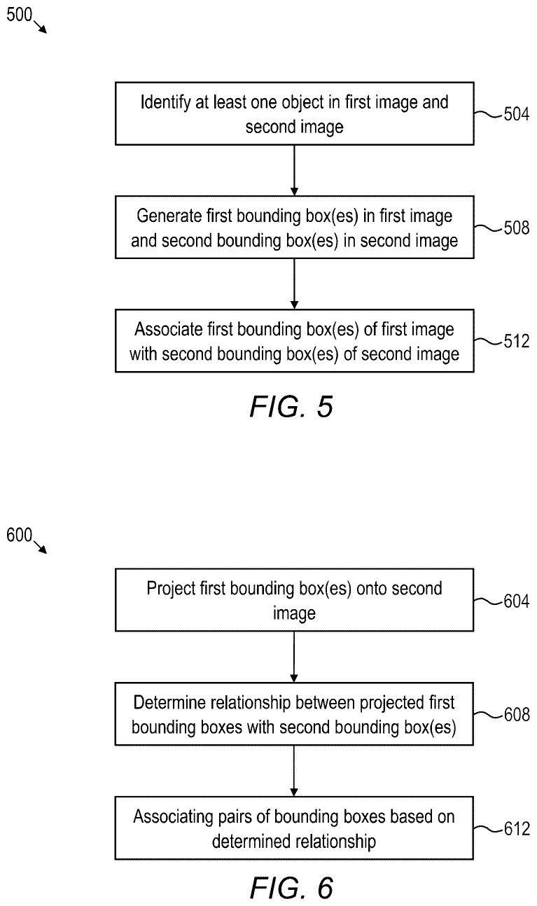

According to some embodiments, method 200 may include operation 216 wherein each of at least one identified object in the first image is associated with a corresponding identified object in the second image, based on the projection matrix approximated in operation 212. Each of the one or more identified objects in the first image may be associated with a corresponding identified object in the second image using any known object matching methods. The association may be based on location using the approximated projection matrix, and additionally based on visual appearance. An example of a method of associating each of the one or more identified objects in the first image with a corresponding identified object in the second image is discussed in relation to FIG. 5.

According to some embodiments, method 200 may optionally include operation 220 wherein the positions of the objects identified within the first image and the second image are plotted on a common image plane. In some embodiments, the one common image plane may cover the 360° surround view of objects around the first, second and further image sensors. This plotting of the positions of identified objects within a common image plane allows the accurate plotting of positions of objects within a scene. The common image plane may be the image plane of the first image, the image plane of the second image, or a separate image plane. The plotting is carried out by projecting the four corner points of each object and/or bounding boxes using the approximated polynomial equation derived for the x-axis and y-axis. In some embodiments, any number of image sensors may be mounted as long as adjacent pairs of image sensors have overlapping fields of view such that objects within adjacent image sensors may be associated with each other and objects may be tracked across multiple cameras can be tracked over a time sequence.

FIG. 5 is a schematic illustration of an exemplary method of associating each of at least one identified object in a first image with a corresponding object in the second image, in accordance with embodiments of the present disclosure. In some embodiments, method 500 of associating each of at least one identified object in a first image with a corresponding object in the second image may be employed in operation 216 of method 200. Method 500 of associating each of at least one identified object in a first image with a corresponding object in the second image may commence with operation 504 wherein at least one object is identified in the first image and at least one object is identified in the second image. The at least one object may be identified using any known object detection or image instance segmentation methods.

According to some embodiments, method 500 may include operation 508 wherein at least one first bounding box is generated in the first image and at least one second bounding box is generated in the second image. A bounding box represents a spatial location of an identified object. Objects may be identified, and bounding boxes may be defined using any known object detection method, such as convolutional neural networks. A CNN is a multi-layered feed-forward neural network, made by stacking many hidden layers on top of each other in sequence. The sequential design may allow CNNs to learn hierarchical features. The hidden layers are typically convolutional layers followed by activation layers, some of them followed by pooling layers. The CNN may be configured to identify pattens in data. The convolutional layer may include convolutional kernels, that are used to look for patterns across the input data. The convolutional kernel may return a large positive value for a portion of the input data that matches the kernel's pattern or may return a smaller value for another portion of the input data that does not match the kernel's pattern. A CNN may be able to extract informative features from the training data without the need for manual processing of the training data. The CNN may produce accurate results where large unstructured data is involved, such as image classification, speech recognition and natural language processing. Also, a CNN is computationally efficient as a CNN is able to assemble patterns of increasing complexity using the relatively small kernels in each hidden layer. A CNN is also advantageous as a CNN has high accuracy in image recognition and can automatically filter images and detect features without any human supervision. An example of a convolutional neural network is YOLOv4, wherein an example of YOLOv4 may be found in “YOLOv4: Optimal Speed and Accuracy of Object Detection” by Bochkovskiy et. al., wherein an example of the architecture of YOLOv4 may be found at least in Section 3 and an example of the training of YOLOv4 may be found at least in Section 4.1. In some embodiments, where the first image and/or the second image is a fisheye image, the convolution filter of the convolutional network may be a restricted deformable convolution (or RDC) module to effectively model the geometric transformation present in fisheye images, wherein the deformation is conditioned on the input features in a local, dense, and adaptive manner. The shape of the RDC is learned to adapt to the changes of features, wherein the shape of the kernel adopts to the unknown complex transformations in the input. In particular, the RDC module learns the sampling matrix with location offsets, wherein the offsets are learned from the preceding feature maps via additional convolutional layers. Detailed information on the RDC module may be found in “Restricted Deformable Convolution based Road Scene Semantic Segmentation Using Surround View Cameras” by Deng et. al.

According to some embodiments, each bounding box detected within an image may be assigned a first tracker identifier (ID) using any known tracker, such as MOTDT tracker disclosed in “Real-time Multiple People Tracking with Deeply Learned Candidate Selection and Person Re-identification” by Chen et. al. The first tracker identifier may be a local track ID, which is a track ID associated with objects identified in images captured by an individual image sensor.

According to some embodiments, method 500 may include operation 512 wherein each first bounding box in the first image is associated with a corresponding second bounding box in the second image. In other words, each first bounding box in the first image is associated with a second bounding box in the second image, the first bounding box and its corresponding second bounding box representing the spatial location of the same object found in the first image captured by the first image sensor and the second image captured by the second image sensor. In some embodiments, each first bounding box in the first image may be assigned a second track identifier (ID), and its associated corresponding second bounding box in the second image may be assigned the same second track identifier (ID). The second track identifier may be a global track ID, which is a track ID associated with objects identified within a scene. This global track ID may be used to label identified objects when the positions of such objects are subsequently plotted on a common image plane.

According to some embodiments, associating each first bounding box with a corresponding second bounding box may be based at least on a relationship between a projection of the first bounding box and the corresponding second bounding box, wherein the projection of the first bounding box is based on the approximated projection matrix, which is further detailed in relation to FIG. 6. According to some embodiments, associating each first bounding box with a corresponding second bounding box may further include determining a visual similarity or dissimilarity between the objects contained within the bounding boxes by identifying at least one feature of each identified object in the first image and at least one feature of each identified object in the second image, and comparing the at least one feature of each identified object in the first image with the at least one feature of each identified object in the second image. This may be advantageous to increase the accuracy of the results in situations where there is a low overlapping region between the first image and the second image.

FIG. 6 is a schematic illustration of a method of associating each first bounding box with a corresponding second bounding box, in accordance with embodiments of the present disclosure. In some embodiments, method 600 of associating each first bounding box with a corresponding second bounding box may be employed in operation 512 of method 500. Method 600 of associating each first bounding box with a corresponding second bounding box may commence with operation 604 wherein the at least one first bounding box from the first image is projected onto the second image to form at least one projected bounding box, wherein each projected first bounding box corresponds to one of the at least one first bounding box. The projection is based on the projection matrix approximated in operation 212 of method 200, wherein the position or coordinates of each first bounding box may be transformed using the approximated projection matrix and then projected onto the second image.

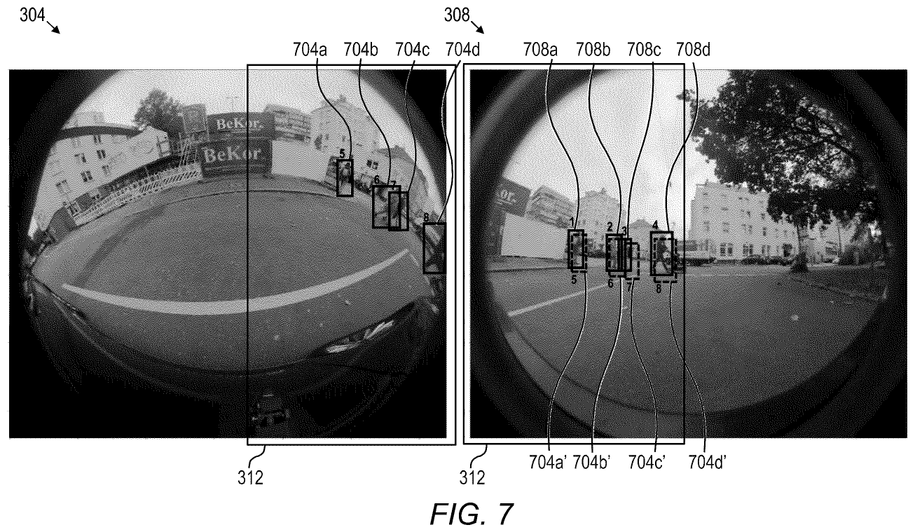

FIG. 7 illustrates example first image 304 and second image 308 after projection according to operation 604 of method 600, in accordance with embodiments of the present disclosure. As shown in FIG. 7, first image 304 includes four first bounding boxes 704a to 704d and second image 308 includes four second bounding boxes 708a to 708d, each bounding box representing a spatial location of a person present in the overlapping region 312 of the first image 304 and second image 308. Each of the first bounding boxes 704a to 704d, and second bounding boxes 708a to 708d are assigned track IDs. As shown in first image 304 in FIG. 7, first bounding box 704a is assigned the track ID 5, first bounding box 704b is assigned the track ID 6, first bounding box 704c is assigned the track ID 7, first bounding box 704d is assigned the track ID 8. As shown in second image 308 in FIG. 7, second bounding box 708a is assigned the track ID 1, second bounding box 708b is assigned the track ID 2, second bounding box 708c is assigned the track ID 3, and second bounding box 708d is assigned the track ID 4. As show in FIG. 7, each of the first bounding boxes 704a to 704d is projected onto second image 308 as projected first bounding boxes 704a′ to 704d′. Each projected first bounding box 704a′ to 704d′ corresponds to a first bounding box 704. Projected first bounding box 704a′ corresponds to first bounding box 704a, projected first bounding box 704b′ corresponds to first bounding box 704b, projected first bounding box 704c′ corresponds to first bounding box 704c, and projected first bounding box 704d′ corresponds to first bounding box 704d. As shown in FIG. 7, although each projected first bounding box 704a′ to 704d′ corresponds to a first bounding box 704a to 704d, the size and relative positions of the bounding boxes may or may not be identical depending on the projection matrix. In the example shown in FIG. 7, as both first image 304 and second image 308 are fisheye images, the geometric relationship between pixels of first image 304 and second image 308 is non-linear and therefore each projected first bounding box 704a′ to 704d′ may not be identical in size to their corresponding first bounding box 704a to 704d.

Returning to FIG. 6, method 600 may include operation 608 wherein a relationship between each projected first bounding box and each second bounding box is calculated. Each determined relationship is a cost for each projected first bounding box-second bounding box pair. For the example illustrated in FIG. 7, a separate relationship or cost between projected bounding box 704a′ and each of second bounding boxes 708a to 708d may be determined, as well as separate relationships or costs between projected first bounding box 704b′, 704c′ and 704d′ and each of the second bounding boxes 708a to 708d.

In some embodiments, the relationship between each projected first bounding box with each second bounding box may include an extent of overlap between each projected first bounding box and each second bounding box. In some embodiments, the extent of overlap between each projected first bounding box and each second bounding box may be determined based on an Intersection over Union (IOU) evaluation matric, which is calculated by dividing the area of overlap between the projected first bounding box and second bounding box by the area of union, i.e., the area encompassed by both the projected first bounding box and second bounding box. The higher the IOU between a projected first bounding box and a second bounding box, the higher the likelihood that the first bounding box corresponding with the projected first bounding box and second bounding box encompass the same object within a scene, and the lower the cost.

According to some embodiments, the relationship between each projected first bounding box with each second bounding box may include a distance between each projected first bounding box and each second bounding box. The distance is between a centre of each projected first bounding box and a centre of each second bounding box. In some embodiments, a Euclidean distance may be calculated between each projected first bounding box and each second bounding box. The shorter the Euclidean distance between a projected first bounding box and a second bounding box, the higher the likelihood that the first bounding box corresponding with the projected first bounding box and second bounding box encompass the same object within a scene, and the lower the cost.

According to some embodiments, method 600 may include operation 612 wherein each first bounding box is associated with a corresponding second bounding box based on the determined relationship between a corresponding projected first bounding box and the corresponding second bounding box. In some embodiments, the determined relationships or costs may be arranged in a cost matrix, which can be used for association in subsequent operations. For example, the cost matrix may be a 2-dimensional matrix, with one dimension being the projected first bounding boxes and the second dimension being the second bounding boxes. Every projected first bounding box-second bounding box pair includes a relationship or cost that is included in the cost matrix. Best matches between the projected first bounding box and second bounding box may be determined by identifying the lowest cost projected first bounding box-second bounding box pair in the matrix. In some embodiments, the association determined using the Hungarian algorithm, also known as the Kuhn Munkres algorithm, which is a combinatorial optimization algorithm that can optimize a global cost across all projected first bounding boxes with second bounding boxes to minimize the global costs. The projected first bounding box-second bounding box combinations in the cost matrix that minimize the global cost can be determined and used as the association. Any other methods may also be used to associate each projected first bounding box with each second bounding box.

According to embodiments of the present disclosure, operation 612 of associating each first bounding box with a corresponding second bounding box may further include identifying at least one feature of each identified object in the first image and second image and comparing the at least one feature of each identified object in the first image with the at least one feature of each identified object in the second image. The identification and comparison of features of identified objects allows increased accuracy of the results as visual similarity of the objects within the first bounding box and its associated second bounding box are also accounted for. In some embodiments, the identification and comparison of features may be carried out separately, using any known algorithms or machine learning methods. For example, the identification or extraction of at least one feature of identified objects in the first image and second image may be carried out using any known feature identification algorithm or machine learning methods, such as a pretrained convolutional neural network (CNN), and a cost can be calculated based on how similar the features look. In some embodiments, where the first image and/or second image is a fisheye image, the convolution filter of the CNN may include an RDC module described above. In some embodiments, the identification and comparison of features may be carried out using any known generative model-based re-identification. In some embodiments, the identification and comparison of features may be carried out using a Siamese network, which is a class of neural networks that contains one or more identical networks. Pairs of identified objects are feed into the one or more identical networks. The one or more identical networks compute the features of one input object, and the similarity of features is computed using their difference or the dot product.

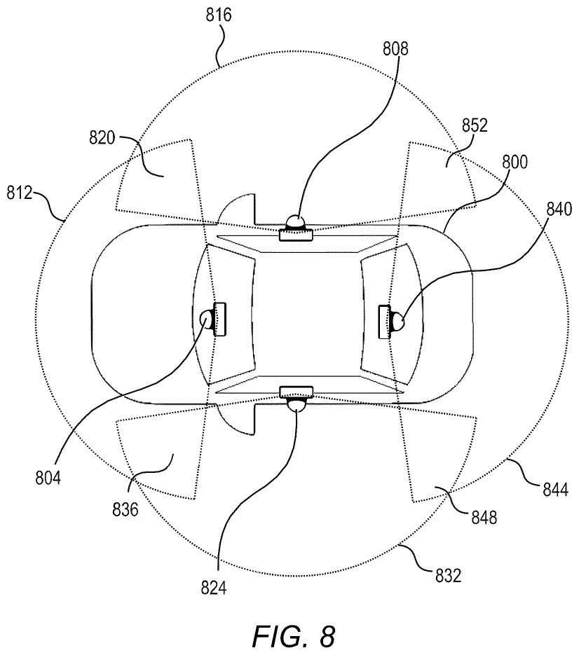

FIG. 8 is a schematic illustration of an example of arrangement of image sensors mounted on a vehicle, in accordance with embodiments of the present disclosure. According to some embodiments, system 100 may be adapted to be used in a vehicle including at least a first image sensor and a second image sensor, one or more processors and a memory that stores executable instructions for execution by the one or more processors, the executable instructions including instructions for performing method 200. In some embodiments, a first image sensor 804 and second image sensor 808 may be mounted on a vehicle 800 such that first image sensor 804 and second image sensor 808 capture images of a scene surrounding vehicle 800. For example, as illustrated in FIG. 8, first image sensor 804 may be mounted on a front of vehicle 800 such that first image sensor 804 captures images of a scene in front of vehicle 800 within a first field of view (FOV) 812. For example, as illustrated in FIG. 8, second image sensor 808 may be mounted on a right of vehicle 800 such that second image sensor 808 captures images of a scene on the right of vehicle 800 within a second field of view (FOV) 816. First image sensor 804 and second image sensor 808 are positioned such that there is an overlapping region 820 between first FOV 812 of first image sensor 804 and second FOV 816 of second image sensor 808. This overlapping region 820 is enables the association of objects in a first image received from first image sensor 804 with corresponding objects in a second image received from second image sensor 808.

According to some embodiments, system 100 and method 200 may be adapted to associate objects over more than two images by including more image sensors, as long as the field of view of the additional image sensors overlap with at least one other image sensor. In some embodiments, method 200 may be adapted such that step 220 includes plotting the positions of identified objects on one common image plane, wherein the one common image plane covers the 360° surround view of objects around the vehicle. For example, system 100 mounted on a vehicle may further include a third image sensor 824 and a fourth image sensor 828. For example, as illustrated in FIG. 8, third image sensor 824 may be mounted on a left of vehicle 800 such that third image sensor 824 captures images of a scene on a left of vehicle 800 within a third field of view (FOV) 832. Third image sensor 824 may be positioned such that there is an overlapping region 836 between first FOV 812 of first image sensor 804 and third FOV 832 of third image sensor 824. For example, as illustrated in FIG. 8, fourth image sensor 840 may be mounted on a rear of vehicle 800 such that fourth image sensor 840 captures image of a scene on a rear of vehicle 800 within a fourth field of view (FOV) 844. Fourth image sensor 840 may be positioned such that there is an overlapping region 848 between third FOV 832 of third image sensor 824 and fourth FOV 844 of fourth image sensor 840, as well as an overlapping region 852 between second FOV 816 of second image sensor 808 and fourth FOV 844 of fourth image sensor 840. In this example, method 200 may be applied between an image received from first image sensor 804 and an image received from second image sensor 808, between an image received from first image sensor 804 and an image received from third image sensor 816, between an image received from third image sensor 816 and an image received from fourth image sensor 840, as well as between an image received from second image sensor 808 and an image received from fourth image sensor. In this example, the one common plane to which the positions of identified objects are plotted on would cover the 360° surround view of objects around the vehicle 800.

FIG. 9 is a schematic illustration of an architecture of a trained neural network for the identification of corresponding points, in accordance with embodiments of the present disclosure. In some embodiments, trained neural network 900 may be employed in operation 208 of method 200. It is emphasized that the architecture illustrated in FIG. 9 is an example, and other suitable architecture may be employed depending on the application and requirements of the user. In some embodiments, trained neural network 900 may be used to identify keypoints in an input image 904. A neural network may include input nodes (i.e., layers), hidden nodes, output nodes.

According to some embodiments, neural network 900 may be trained on a scene classification dataset. In some embodiments, the scene classification dataset may include images of different scenes captured from different cameras mounted on an ego vehicle. In some embodiments, the scene classification dataset may include images sorted into scene classes. For example, the scene classification dataset may include images sorted into at least 500 number of classes, wherein each class includes at least 70 images. In some embodiments, the number of classes may be based on the likely environments that the system 100 may be employed. In some embodiments, a single class of a scene representing the same scene content may include a sequence of images captured from an image sensor that captures overlapping regions of a scene and may further include a sequence of images captured at the same time period by other image sensors that have an overlapping field of view with the first-mentioned image sensor. In some embodiments, a single class of a scene may further include images that have been altered from the aforementioned images using image scaling and random cropping to increase the number of images in the class, as long as the overlapping region is retained. In some embodiments, when training neural network 900, pairs of images from the same class may be designated as matched pairs, while pairs of images from different class may be designated as non-matched pairs.

According to some embodiments, the trained neural network 900 may include a convolutional neural network (CNN) backbone 908 for the extraction of features, and a keypoint extractor 916 to identify keypoints from the features extracted by the CNN backbone 908. In some embodiments, trained neural network 900 may be trained with a batch size of 16 for 25 epochs, with optimisation using stochastic gradient descent (SGD) with a momentum of 0.9. In some embodiments, a decaying learning rate may be used till the rate reaches zero and learning rate initialisation may be between 0.0003 to 0.01. In some embodiments, training of the keypoint extractor 916 and CNN backbone 908 may be carried out independently for the learning of stronger local descriptors. In some embodiments, CNN backbone 908 may be trained and refined first, and the keypoint extractor 916 may subsequently be trained, such that only the weights of the keypoint extractor 916 are learnt without disturbing the trained and refined CNN backbone 908.

Examples of CNN backbone 908 include ResNet-50 and ResNet-101 which may be found in “Deep Residual Learning for Image Recognition”, wherein the architecture of ResNet-50 and ResNet-101 may be found in at least in Section 3, Table 1, and FIG. 5, and the training of the ResNet-50 and ResNet-101 may be found at least in Section 3.4. An example of the architecture of ResNet-50 and ResNet-101 are reproduced in Table 1 below.

In some embodiments, where the first image and/or second image is a fisheye image, the convolution filter of the CNN backbone 908 may include an RDC module described above.

TABLE 1
Architecture of ResNet-50 and ResNet-101

| | | ResNet-50 | ResNet-101 |
|---|---|---|---|
| Layer Name | Output Size | (50-layer) | (101-layer) |
| conv1 | 112 × 112 | 7 × 7, 64, stride 2 | |
| conv2_x | 56 × 56 | 3 × 3 maxpool, stride 2 | |
| | | $[ \begin{matrix}1 \times 1 , 64 \\ 3 \times 3 , 64 \\ 1 \times 1 , 256\end{matrix} ] \times 3$ | $[ \begin{matrix}1 \times 1 , 64 \\ 3 \times 3 , 64 \\ 1 \times 1 , 256\end{matrix} ] \times 3$ |
| conv3_x | 28 × 28 | $[ \begin{matrix}1 \times 1 , 128 \\ 3 \times 3 , 128 \\ 1 \times 1 , 512\end{matrix} ] \times 4$ | $[ \begin{matrix}1 \times 1 , 128 \\ 3 \times 3 , 128 \\ 1 \times 1 , 512\end{matrix} ] \times 4$ |
| conv4_x | 14 × 14 | $[ \begin{matrix}1 \times 1 , 256 \\ 3 \times 3 , 256 \\ 1 \times 1 , 1024\end{matrix} ] \times 6$ | $[ \begin{matrix}1 \times 1 , 256 \\ 3 \times 3 , 256 \\ 1 \times 1 , 1024\end{matrix} ] \times 23$ |
| conv5_x | 7 × 7 | $[ \begin{matrix}1 \times 1 , 512 \\ 3 \times 3 , 512 \\ 1 \times 1 , 2048\end{matrix} ] \times 3$ | $[ \begin{matrix}1 \times 1 , 512 \\ 3 \times 3 , 512 \\ 1 \times 1 , 2048\end{matrix} ] \times 3$ |

| | |
|---|---|
| 1 × 1 | average pool, 1000-d fc, softmax |

| | | |
|---|---|---|
| FLOPs | 3.8 × 10⁹ | 7.6 × 10⁹ |

According to some embodiments, the CNN backbone 908 may include one or more shallow layers 924 and one or more deep layers 930. For example, where the CNN backbone 908 is ResNet-50 or ResNet-101, layers conv1, conv2_x, conv3_x and conv4_x may be shallow layers 924, and layer conv5_x may be a deep layer 930. In some embodiments, output from a shallow layer 924 may be input into keypoint extractor 916 to identify as keypoints a subset of features from the densely extracted features extracted by the shallow layers 924 of the CNN backbone 908. For example, where the CNN backbone 908 is ResNet-50 or ResNet-101, the output from layer conv4_x may be input into the keypoint extractor 916 to identify keypoints. In some embodiments, the output from shallow layer 924 may include 1024 channels and may be expressed as 14×14 ×1024, which means that each element in a 14×14 matric has 1024 feature vectors. In some embodiments, the 196 elements in a 14×14 matrix may correspond to 196 overlapping patches (or local descriptors) from a 512×512 input image, such that each patch may have 1024 sized feature vector or local descriptor. The output from a shallow layer 924 is used to extract keypoints as the feature map generated by shallow layer 924 includes information about local features in an input image, as compared to the output from the deep layer 930 which includes information on global features that describe the entire image. The deeper the layer, the more abstract and high-level the semantic properties. Shallow layers 924 generate shallow feature maps which represent low-level local features which include descriptors and geometry information about specific image regions, such as objects, while deep layers 930 generate deep feature maps which represent global features that summarise the content of an image, but do not contain information about the spatial arrangement of visual elements.

According to some embodiments, CNN backbone 908 may be pretrained on a labelled image classification and localization dataset, such as the ImageNet dataset available at https://image-net.org/download.php. Dense features may be extracted from input image 904 by applying a Fully Convolutional Network (FCN) taken from ResNet-50, using the output of conv4_x convolutional block of ResNet-50. To handle the scale changes, aₙ image pyramid may be constructed, and FCN may be applied at each level explicitly. The feature maps obtained may be considered as a dense grid of local descriptors, and features may be localized based on their receptive fields, which may be computed based on the configuration of convolutional and pooling layers of the FCN. In some embodiments, the pixel location of features may be determined by taking a centre of their receptive field. In some embodiments, to enhance the discriminativeness of local descriptors, the ResNet-50 model may be fine-tuned for scene classification by training the ResNet-50 model with the above-described scene classification dataset and using cross-entropy loss such that local descriptors learn better representations for scene without using object level and patch level labels.

According to some embodiments, keypoint extractor 916 may receive as input the output from shallow layer 924 of CNN backbone 908. In some embodiments, keypoint extractor 916 may include an attention model 936 that selects a subset of features from the densely extracted features from shallow layer 924 of CNN backbone 908 and a dimension reducer 942 to reduce the dimensionality of features. In some embodiments, the dimension reducer 942 may include PCA (Principal Component Analysis) or an autoencoder. In some embodiments, dimension reducer 942 may generate the local descriptor for the keypoints of the subset of features selected by attention model 936.

According to some embodiments, keypoint extractor 916 may include PCA and L2 normalisation as dimension reducer 942. In particular, the dimensionality of the feature maps may be L₂ normalised and their dimensionality may be reduced from 1024 to 40 by PCA, followed by an additional L₂ normalisation.

According to some embodiments, keypoint extractor 916 may include an autoencoder as dimension reducer 942. In some embodiments, the autoencoder may reduce the dimensionality of the feature maps from 1024 to 128. In some embodiments, the autoencoder may be a convolutional autoencoder module which learns a suitable low-dimensional representation of feature maps. In some embodiments, the autoencoder may be trained with a cross-entropy classification loss L, with weight λ=10.

According to some embodiments, the attention model 936 may be used to predict which among the densely extracted features are discriminative for the objects in an image by learning the weightage of local descriptors. In some embodiments, attention model 936 may determine whether which features are discriminative based on a keypoint detection score. In some embodiments, attention model 936 may remove redundant local descriptors based on the relevance of the local descriptors, such that the remaining local descriptors are keypoint descriptors 950, wherein such keypoint descriptors 950 correspond to the keypoints identified in an image. In some embodiments, attention model 936 may include two convolutional layers, without stride, using convolutional filers of size of 1×1, with ReLU as the activation function for the first convolutional layer and softplus as the activation function for the second convolutional layer. In some embodiments, the attention model may be trained by using a weighted sum of local descriptors followed by using a standard softmax-cross-entropy loss with weight β=1. In some embodiments, attention pooling may be employed on the keypoint descriptors 950 to determine the exact location of the keypoints identified in an image.

The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. The terms “comprises”, “comprising”, “includes” or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

1. A vehicle comprising a vehicle system for associating objects over two or more images, wherein the vehicle system comprises at least a first image sensor and a second image sensor, one or more processors and a memory that stores executable instructions for execution by the one or more processors, the executable instructions comprising instructions for performing a computer-implemented method comprising:
receiving a first image from the first image sensor and a second image from the second image sensor;
identifying corresponding points between the first image and the second image;
approximating a projection matrix between the first image and the second image based on the identified corresponding points; and
associating at least one identified object in the first image with a corresponding identified object in the second image based at least on the approximated projection matrix.

2. The vehicle according to claim 1, wherein the computer-implemented method further comprises:
plotting positions of the at least one identified objects on one common image plane, wherein the one common image plane covers the 360° surround view of objects around the vehicle.

3. A computer-implemented method for associating objects over two or more images, the method comprising:
receiving a first image from a first image sensor and a second image from a second image sensor;
identifying corresponding points between the first image and the second image;
approximating a projection matrix between the first image and the second image based on the identified corresponding points; and
associating at least one identified object in the first image with a corresponding identified object in the second image based at least on the approximated projection matrix.

4. The computer-implemented method according to claim 3, wherein at least one of the first image sensor or the second image sensor is a fisheye camera.

5. The computer-implemented method according to claim 3, wherein:
the corresponding points are distinct points, including points that correspond to a vertex or an intersection.

6. The computer-implemented method according to claim 3, wherein the corresponding points are selected using a neural network, and the neural network comprising a convolutional neural network backbone and a keypoint extractor, wherein the convolutional neural network backbone comprises a restricted deformable convolution module.

7. The computer-implemented method according to claim 3, wherein approximating the projection matrix includes the approximating at least one projection matrix comprising at least one polynomial equation, wherein the at least one polynomial equation has a degree of n and a number of the corresponding points identified is between n+1 and n+7, wherein n is an integer equals to or more than 2.

8. The computer-implemented method according to claim 3, wherein the projection matrix comprises two polynomial equations: a first polynomial equation for coordinates on an x-axis, and a second polynomial equation for coordinates on a y-axis.

9. The computer-implemented method according to claim 3, wherein associating at least one object in the first image with a corresponding object in the second image comprises:
identifying at least one object in the first image and at least one object in the second image;
generating at least one first bounding box in the first image and at least one second bounding box in the second image, each of the at least one first bounding box and at least one second bounding box representing a spatial location of an identified object; and
associating each first bounding box with a corresponding second bounding box at least based on a relationship between a projection of the first bounding box and the corresponding second bounding box, wherein the projection is based on the approximated projection matrix.

10. The computer-implemented method of claim 9, wherein associating each first bounding box with a corresponding second bounding box comprises:
projecting the at least one first bounding box on the second image based on the approximated projection matrix to generate at least one projected first bounding box on the second image, wherein each projected first bounding box corresponds to one of the at least one first bounding box;
determining a relationship between each projected first bounding box with each second bounding box; and
associating each first bounding box with a corresponding second bounding box based on the determined relationship between a corresponding projected first bounding box and the corresponding second bounding box.

11. The computer-implemented method of claim 10, wherein the relationship between each projected first bounding box with each second bounding box comprises at least one of:
an extent of overlap between each projected first bounding box and each second bounding box; or
a distance between each projected first bounding box and each second bounding box, wherein the distance is between a center of each projected first bounding box and a center of each second bounding box.

12. The computer-implemented method of claim 9, wherein associating each first bounding box with a corresponding second bounding box further comprises:
identifying at least one feature of each identified object in the first image and the second image, wherein the at least one feature is an appearance feature vector; and
comparing the at least one feature of each identified object in the first image with the at least one feature of each identified object in the second image.

13. The computer-implemented method of claim 3, further comprising plotting positions of identified objects on one common image plane, wherein the one common image plane covers the 360° surround view of objects around the first, second and further image sensors.

14. The computer-implemented method of claim 3, wherein
the first image sensor and second image sensor are fisheye cameras and are positioned such that there is an overlap between the at least one first image of the scene captured by the first image sensor and the at least one second image of the scene captured by the second image sensor;
the corresponding points are selected using a neural network comprising a convolutional neural network backbone and a keypoint extractor, wherein the neural network is trained on a scene classification dataset comprising images sorted into scene classes, wherein each scene class comprises a sequence of images captured from a single fisheye camera that captures overlapping regions of a scene and a sequence of images captured at a same time period by other of the fisheye cameras that have an overlapping field of view with the single fisheye camera, and wherein the convolutional neural network backbone comprises a restricted deformable convolution module;
the approximated projection matrix comprises a first polynomial equation for coordinates on an x-axis, and a second polynomial equation for coordinates on a y-axis, wherein the first polynomial equation and the second polynomial equation each has a degree of two and a number of corresponding points identified is three;
associating at least one identified object in the first image with a corresponding identified object in the second image comprises:
identifying the at least one object in the first image and the at least one object in the second image;
generating at least one first bounding box in the first image and at least one second bounding box in the second image, each of the at least one first bounding box and the at least one second bounding box representing a spatial location of an identified object;
projecting the at least one first bounding box on the second image based on the approximated projection matrix to generate at least one projected first bounding box on the second image, wherein each projected first bounding box corresponds to one of the at least one first bounding box;
determining an extent of overlap between each projected first bounding box and each second bounding box; and
associating each first bounding box with a corresponding second bounding box based on the determined extent of overlap between a corresponding projected first bounding box and the corresponding second bounding box.

15. A non-transitory computer readable storage medium that comprises instructions, that upon execution on one or more processors, cause the one or more processors to perform a computer-implemented method for associating objects over two or more images, the method comprising:
receiving a first image from a first image sensor and a second image from a second image sensor;
identifying corresponding points between the first image and the second image;
approximating a projection matrix between the first image and the second image based on the identified corresponding points; and
associating at least one identified object in the first image with a corresponding identified object in the second image based at least on the approximated projection matrix.

16. The computer-implemented method according to claim 3, wherein the first image sensor and second image sensor are positioned such that there is an overlap between the at least one first image of the scene captured by the first image sensor and the at least one second image of the scene captured by the second image sensor.

17. The computer-implemented method according to claim 3, wherein the corresponding points are keypoints.

18. The computer-implemented method according to claim 3, wherein approximating the projection matrix includes the approximating at least one projection matrix comprising at least one polynomial equation, wherein the at least one polynomial equation has a degree of 2 and the number of corresponding points identified is between 3 and 9.
